(19) United States
(12) Patent Application Publication
(10) Pub. No.: US 2002/0095378 A1
(43) Pub. Date: Jul. 18, 2002

(54) Service provider network for legal services with direct browser delivery of rich text format documents

(76) Inventors: Mark P. Cauchon, Baltimore, MD (US); Glenn S. Kohne, Parkton, MD (US)

Correspondence Address: Law Offices of Royal W. Craig, Suite 153, 10 North Calvert Street, Baltimore, MD, 21202, US

(21) Appl. No.: 10/004,271

(22) Filed: Oct. 31, 2001

Related U.S. Application Data
(60) Provisional application No. 60/244,676, filed on Oct. 31, 2000.

(51) Int. Cl. G06F 17/60

(52) U.S. Cl. 705/40

(57) ABSTRACT

A method for automated and efficient provision of professional legal documents and services. The provision of legal forms to a user by a lawyer is facilitated over an electronic communications link. The method entails establishing a communications link to permit a lawyer to provide legal advice to a user, receiving payment for the legal advice based on user information, and restricting access by the lawyer to a portion of the user information to maintain anonymity. The method generates customized situation-specific legal documents directly to the user's computer, and it does so without the risk of conflicts of interest, thereby substantially simplifying and streamlining the rendering of legal advice to users. Immediate rich text format (rtf) document delivery is accomplished directly to a secondary browser window so that subscribers are free to modify the documents at will.

### CROSS-REFERENCED TO RELATED APPLICATIONS

The present application derives priority from U.S. Provisional Patent Application No. 60/244,676 for “SERVICE PROVIDER NETWORK FOR LEGAL SERVICES WITH DIRECT BROWSER DELIVERY OF RICH TEXT FORMAT DOCUMENTS”; Filed: Oct. 31, 2000; Applicants: Mark P. Cauchon & Glenn S. Kohne

### BACKGROUND OF THE INVENTION

1. Field of the Invention

The present invention relates to web-enabled custom document delivery and, more particularly, to a system for direct browser delivery of customized rich text format (rtf) legal documents.

2. Description of the Background

Traditional legal services are very expensive, time consuming and beyond the reach of many households. Those who can afford representation often don't because of the high cost of retaining counsel. As a result, most people are effectively without any accurate information or advice about everyday legal problems that confront them. Very often this means their problem will be ignored and will likely worsen.

One reason why no existing service has met this need is the fact that most if not all of such services are relatively inefficient from a business standpoint. For example, due to ethics requirements in most states, lawyers are required to perform “conflict checks” prior to rendering any legal advice which can be relatively time consuming, and add to the time and cost overhead associated with assisting clients. Moreover, most lawyers have been trained with the mind set of tackling a legal problem from start to finish, performing legal research as necessary and taking all relevant information from the client before rendering any legal advice. Lawyers also typically are available to take client calls only during normal business hours, and work flow can vary substantially from day to day, so maintaining optimum workflow can be difficult. Furthermore, particularly with lower income clients, obtaining payment from clients may be difficult, and receiving payment and collecting delinquent accounts can affect profitability and otherwise take time away from actually rendering legal services to clients. For these and other reasons, conventional legal service providers are incapable of efficiently rendering legal advice for many individuals. A significant need therefore exists for an improved manner of efficiently and cost effectively rendering legal advice and performing other professional services for individuals.

Some lower cost alternatives do exist for assisting people in handling legal matters on their own behalf. However, often such alternatives are limited in scope. There currently exist some commercially-available legal document generation software products. Such products, however, often attempt to avoid rendering any legal advice, and recommend the guidance of a lawyer. The range and detail of answers to particular questions are also often extremely limited.

There are also a small number of internet legal service providers that offer written legal opinions and documents online. As a whole, these are far more efficient than the traditional approach, but their business model results in legal advice and document delivery that is inconvenient. The subscriber must often wait a long time and/or go to great technical troubleshooting lengths to get the document or opinion for which they paid. Once they get it, they are inevitably faced with compatibility issues and must often reformat the entire document themselves on their word processor. Surveying the internet legal service providers, there are currently three mechanisms for automated internet document delivery. First, some sites use email delivery. For example, Invisible hand Software at htt://www.quickforms.net/ produces QuickForm Contracts for the computer industry, Internet commerce and general business transactions. The user selects a category of document to draft, answers the questions as they are presented, and the document is delivered in user-selectable formats by email. Once the document is received, it can be modified using a word processor. Unfortunately, delivery by email often takes significant time, and this mode of delivery is incongruous with many applications of online legal service delivery. For example, if an online service provider wanted to place an internet-enabled kiosk in a mall or courthouse for onsite document generation, email delivery would be useless because most users would have no access to their normal email accounts.

Another mechanism is by direct delivery to the subscriber's web browser. For example, Legaldocs® at http://www.legaldocs.com produces Legal Documents Online, a web site that allows subscribers to prepare customized legal documents. The subscriber chooses a document type from a menu, completes a number of questions, and a finished document is output in the browser window in Hypertext Markup Language (HTML) format ready for downloading or printing. HTML is an Internet-standard way of representing formatting such as bold text or colored fonts. All Web pages use HTML, as do many popular e-mail clients.

Unfortunately, HTML format is incompatible with most word processing software and the subscriber cannot easily put finishing touches on the document. If they cut and paste the text out of their browser and into their word processor, much formatting is lost and time is wasted retyping.

Similarly, a few online document delivery services generate proprietary file formats which use plug-ins such as Adobe Acrobat to decipher. Not everyone has the time or technical saavy to download the plug-in to read these files. Moreover, there is no cutting and pasting of these documents and the subscriber cannot change them at all.

A significant need has thus arisen for an efficient, useful and moderate mechanism for delivering electronic legal documents to subscribers which frees them to modify the documents at will.

RTF (Rich Text Format) was designed by Microsoft as an open format for interchanging documents between Microsoft Word and other word processing packages. The Rich Text Format (RTF) Specification is a method of encoding formatted text and graphics for easy transfer between applications, and text and graphics interchange that can be used with different output devices, operating environments, and operating systems. RTF is an excellent document format for subscribers, but it is not easy to deliver directly to a browser. Most RTF documents produced by word processors are not readily portable to a browser window. As a result, it is difficult to implement completely and correctly. A significant need has thus arisen for an efficient RTF document delivery method immediately and directly to a browser window so that subscribers are free to modify the documents at will.

### SUMMARY OF THE INVENTION

It is, therefore, an object of the present invention to provide a method.

According to the present invention, the above-described and other objects are accomplished by providing a method for automated and efficient provision of professional documented services, particularly in the area of providing legal advice and legal documents. Consistent with one aspect of the invention, the provision of legal advice to a user by a lawyer is facilitated by receiving user information from a user over an electronic communications link, establishing an electronic communications link between the user and a lawyer to permit the lawyer to provide legal advice to the user, receiving payment for the legal advice using at least a portion of the user information received from the user, and restricting access by the lawyer to at least a portion of the user information received from the user to maintain anonymity of the user relative to the lawyer. By managing the flow of user information to permit both payment to be received, but the anonymity of the user to be maintained relative to the lawyer, legal advice may be rendered without the risk that the lawyer could use any information learned from that user in a manner adverse to someone that the lawyer has a professional relationship. As such, the need to perform conflict checks on users can be avoided, thereby substantially simplifying and streamlining the rendering of legal advice to users. The method ends with immediate RTF document delivery directly to a browser window so that subscribers are free to modify the documents at will.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a flowchart illustrating a service provider network (SPN) 10 consistent with the present invention.

FIG. 2 illustrates the format of a user record 100 for storing user information.

FIG. 3 is a flow chart illustration of the sequence of operations performed by a receptionist in handling a call, or contact, from a user desiring service.

FIG. 4 next illustrates the handling of service from the perspective of a lawyer, as represented at 300.

FIG. 5 is a block diagram of the specific document delivery architecture for direct browser delivery of rich text format documents in accordance with the method of FIG. 4.

FIG. 6 is a screen print of an exemplary purchase page.

FIG. 7 is an example of an auto bill of sale questionnaire.

FIG. 8 is a top-level flow chart implementation of the VB script logic engine

FIG. 9 is an exemplary visual basic implementation of flow charts of FIGS. 5 and 8.

### DETAILED DESCRIPTION OF THE PREFERRED EMBODIMENTS

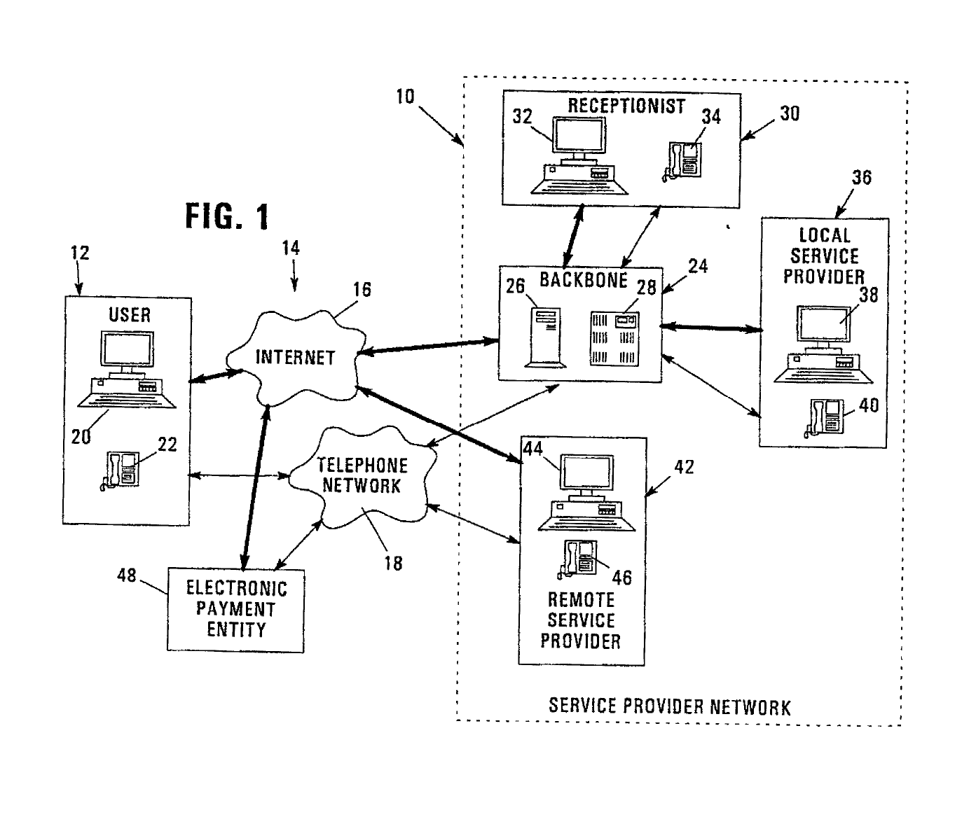

FIG. 1 illustrates a service provider network (SPN) 10 consistent with the invention. SPN 10 operates as a computing platform for providing services to a plurality of users 12 coupled thereto over an electronic communications network 14. Users may couple to SPN 10 through any number of electronic communications media, e.g., a global public network such as the Internet 16 and/or a public telephone network 18. Other electronic communications media, including point-to-point or other private voice and/or data networks, may also be used. A user may couple to an SPN over voice and/or data electronic communications links. For example, a user 12 may couple to an SPN through electronic communications links provided in a computer 20 and/or a telephone 22. It should be appreciated that a user can access SPN 10 through a computer or a telephone or both in various applications of the invention. SPN 10 includes a backbone 24 including a multi-user computer system 26 (including one or more computers) and/or an internal phone network (represented by PBX 28). Any number and combination of computer data and/or voice networks may be utilized within backbone 24 in different applications. The efficient and cost-effective provision of services to users is principally obtained through an efficient allocation of resources between one or more receptionists 30 and one or more service providers 36, 42. Each receptionist 30 handles incoming service requests from users and performs other tasks such as obtaining demographic information and payment information, among other functions discussed in greater detail below. Service providers represent the persons that actually perform the services requested by a user, typically by those professionally trained as experts in providing such services. Each receptionist is typically coupled to backbone 24 through the use of a computer 32 and telephone 34. Likewise, a service provider may be coupled to backbone 24 either as a local service provider 36 (via an internal network link using a computer 38 and telephone 40), or as a remote service provider 42 (via an external network link using a computer 44 and telephone 46). Typically, each remote service provider 42 is coupled to the backbone at least partially through a public electronic communications medium such as the Internet 16 and/or public telephone network 18. Any number of receptionist and/or service providers may be utilized consistent with the invention. Moreover, service providers may be restricted to only local or remote access to backbone 24. Furthermore, the functionality of backbone 24 may be distributed amongst the various service providers and receptionists.

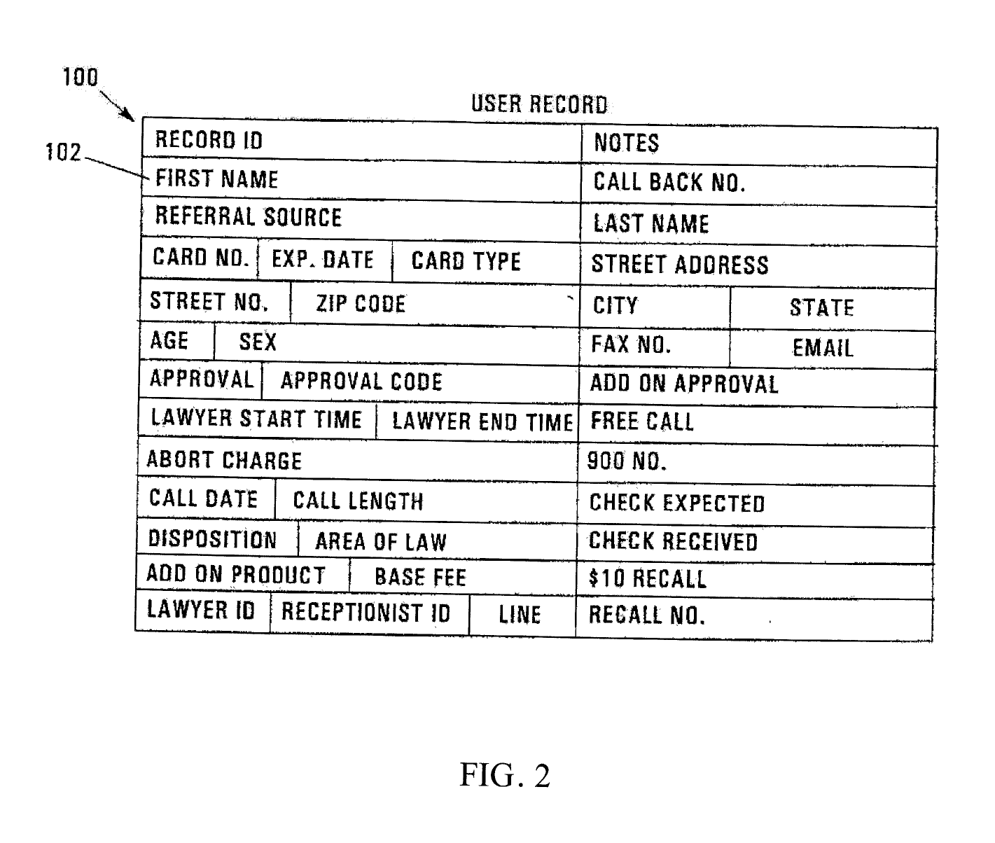

As discussed above, user database 94 maintains a database of user information regarding the users of the service provider network. Such user information may be stored in a user record, e.g., having the format of user record 100 of FIG. 2, which includes a plurality of fields 102. A user record may contain various arrangements and types of user information and user management information, as well as demographic and other statistical information for use in tracking service performance. The precise information will typically vary in different applications. For example, as shown in FIG. 2, the following fields may be supported in a user record consistent with the invention (the use of which are discussed in greater detail below):

Record ID—a unique identifier for the record

First Name—the first name of the user

Referral Source—the source of the contact

Card No./Exp. Date/Card Type—credit card payment information

Street No./ZIP—the user's home street number and ZIP code

Age/Sex—user demographic information

Approval—a flag indicating when payment is approved

Approval Code—the authorization code provided as a result of credit card authorization

Lawyer Start/End Times—start and end times of a contact

Abort Charge—flag to abort payment

Call Date/Length—day and length of contact

Disposition—result of contact (e.g., charge, write off, suspend)

Area of Law—legal topic for which advice received

Add On Product—indication of what add on products were purchased

Base fee—cost of add on products

Lawyer ID/Receptionist ID—user ID's of lawyer/receptionist handling user′

Line—telephone line over which contact handled

Notes—lawyer's notes on contact

Call Back No.—telephone number to call user after suspend

Last Name/Street Address/City/State/Fax No./Email—Delivery

Free Call—flag indicating user not billed

900 No.—flag indicating payment by 900 No. or other direct phone billing

Check Expected—date user has indicated check/money order will be mailed by

Check Received—date check/money order received from user

$10 Recall—flag indicating user has taken advantage of recall option

Recall No.—telephone number for reaching user

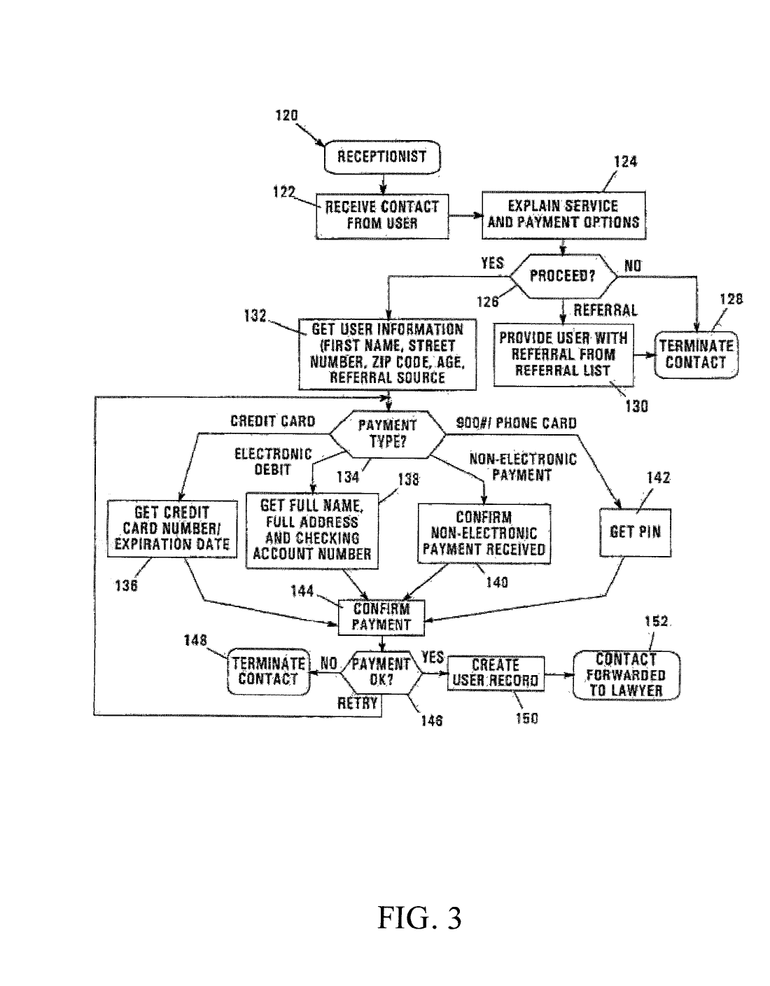

FIG. 3 next illustrates at 120 the sequence of operations performed by a receptionist in handling a call, or contact, from a user desiring services from the service provider network. In general, a receptionist receives a contact from a user as represented at block 122, and initially explains the service and payment options available to that user in block 124. Based upon the service and payment options presented to the user, a user may decide whether and how to proceed with the service provider network. In general, as represented at block 126, a user may decide that he or she is not interested in receiving services, whereby the contact will be terminated in block 128. On the other hand, the user or the receptionist may determine that the user's particular situation cannot be handled by the service provider network, and that instead a referral to an appropriate agency would be appropriate. In such instances, the user is provided with a referral from a referral list in block 130, and the contact is terminated (block 128). In addition, after having the service and payment options explained to the user, the user may desire to proceed with obtaining service from the service provider network, whereby the receptionist then obtains user information from the user as represented at block 132. Among such user information includes demographic information suitable for the SPN retrieving adequate assurance of payment for service. For example, for credit card transactions, it has been determined that the first name, the street number and the zip code of a user's billing address is sufficiently devoid of fraud that a credit card company will accept such information as proof of authorization to debit a credit card account. Additional information, e.g., age, sex, and a referral source, as well as other demographic information, may also be obtained.

Once demographic information has been obtained from a user, the user then determines what type of payment will be used to pay for the services. As shown at block 134, a number of different payment types may be utilized to pay for the desired services. Once the suitable payment information has been received, the receptionist next confirms payment as represented at block 144. Confirmation of the payment varies depending upon the particular type of payment being made by a user. Based upon whether the payment has been assured, a contact with a user is either terminated or forwarded on to the lawyer. If, however, payment has been assured, the receptionist then creates a user record as represented at block 150, and forwards contact to the lawyer as represented at block 152. Contacts may be transferred between a receptionist and a lawyer in a number of different manners depending upon both the underlying hardware platform and the type of contact.

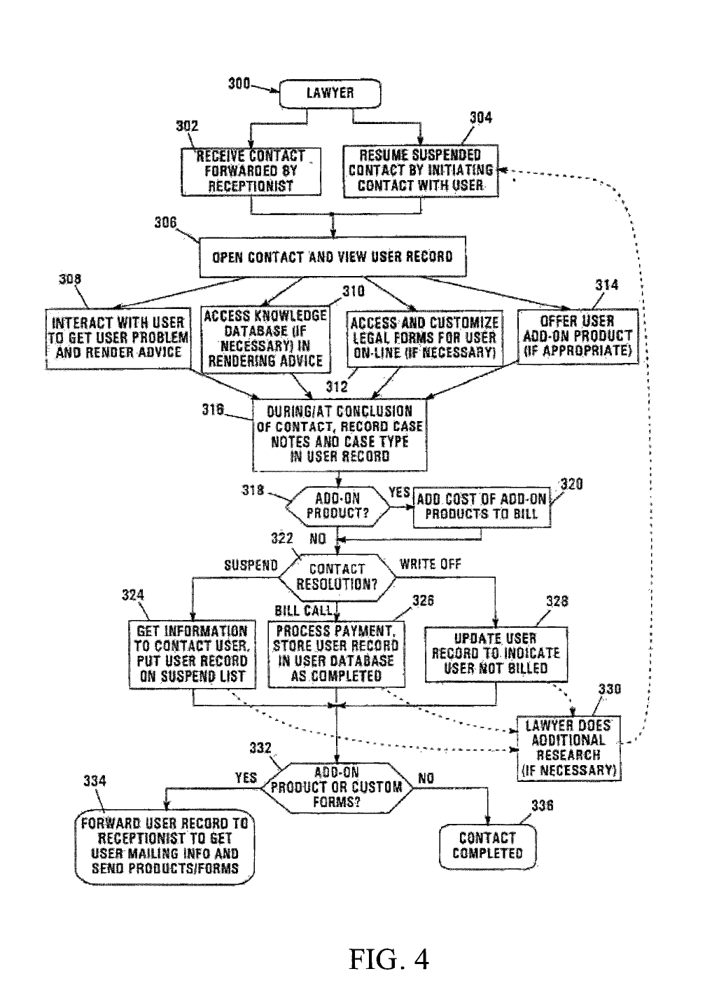

To implement the functionality described above in connection with routine 120, FIG. 4 next illustrates the handling of service for a user from the perspective of a lawyer, as represented at 300. A lawyer may process a contact with a user in one of two manners represented by blocks 302 and 304. First, a lawyer may receive a contact forwarded by a receptionist. In the alternative, as represented at block 304, the lawyer may choose to resume a suspended contact by initiating contact with the user, e.g., by phoning the user directly. Regardless of how the contact is initiated, however, the lawyer next opens the contact and views the user record associated with that contact (block 306). Next, as represented by blocks 308-314, the lawyer renders legal advice to the user by interacting with the user and attempting to render advice based upon the user's particular problems and questions. As shown by block 310, during this interaction, the lawyer may access a knowledge database to assist in the quick and efficient rendering of advice. Moreover, as represented at block 312, the lawyer may access and customize legal forms for the user while the lawyer is online with the user, e.g., using a custom form generator application 96 (FIG. 3) to assist the user in obtaining relevant legal documents for his or her particular problem.

In addition, during the rendering of advice, the lawyer may offer the user an add-on product if appropriate, as represented by block 314. An add-on product may represent, for example, any number of packages that a user may have interest in to assist him or her in performing legal representing pro se. For example, a user may be encouraged to purchase add-on products such as papers for filing and proceeding through a no-fault divorce, papers for filing and proceeding in a child custody action, materials for drafting wills and other estate planning documents, small claims, articles of incorporation, debt collection, simple pleadings, credit restoration, domestic relations matters, and other legal documents. Moreover, as represented at block 316, during the rendering of advice and interaction with a user, the lawyer may also draft notes and/or opinions.

In any of the foregoing instances, custom document assembly and delivery is required to the user. In accordance with the present invention, an efficient, useful and convenient mechanism is disclosed for delivering electronic legal documents in RTF format to users immediately and directly to a new browser window which allows users to modify the documents at will.

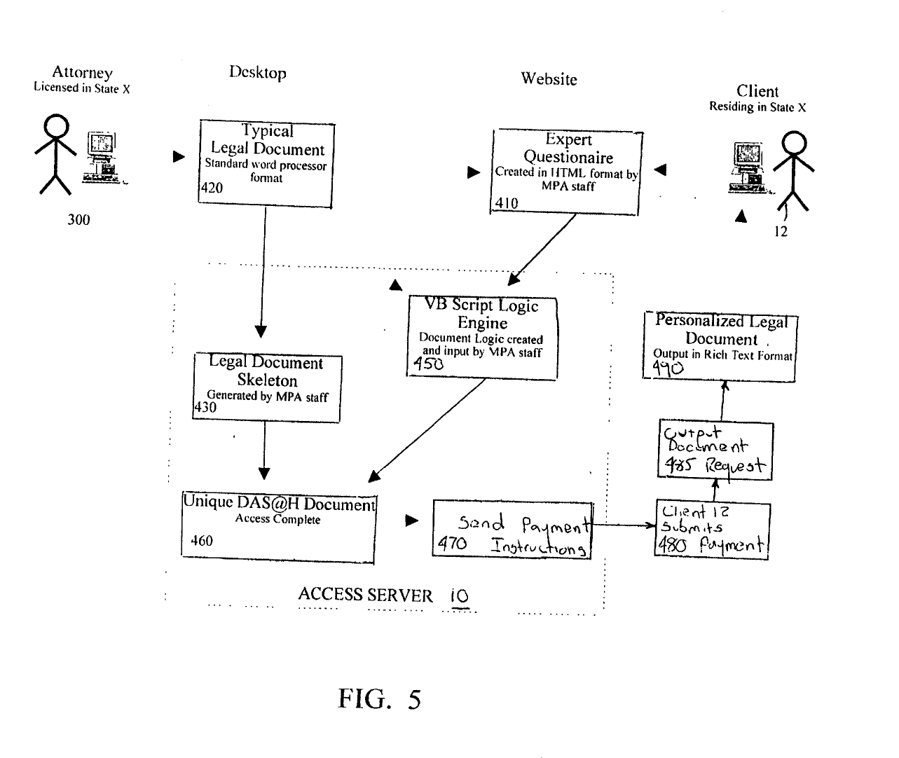

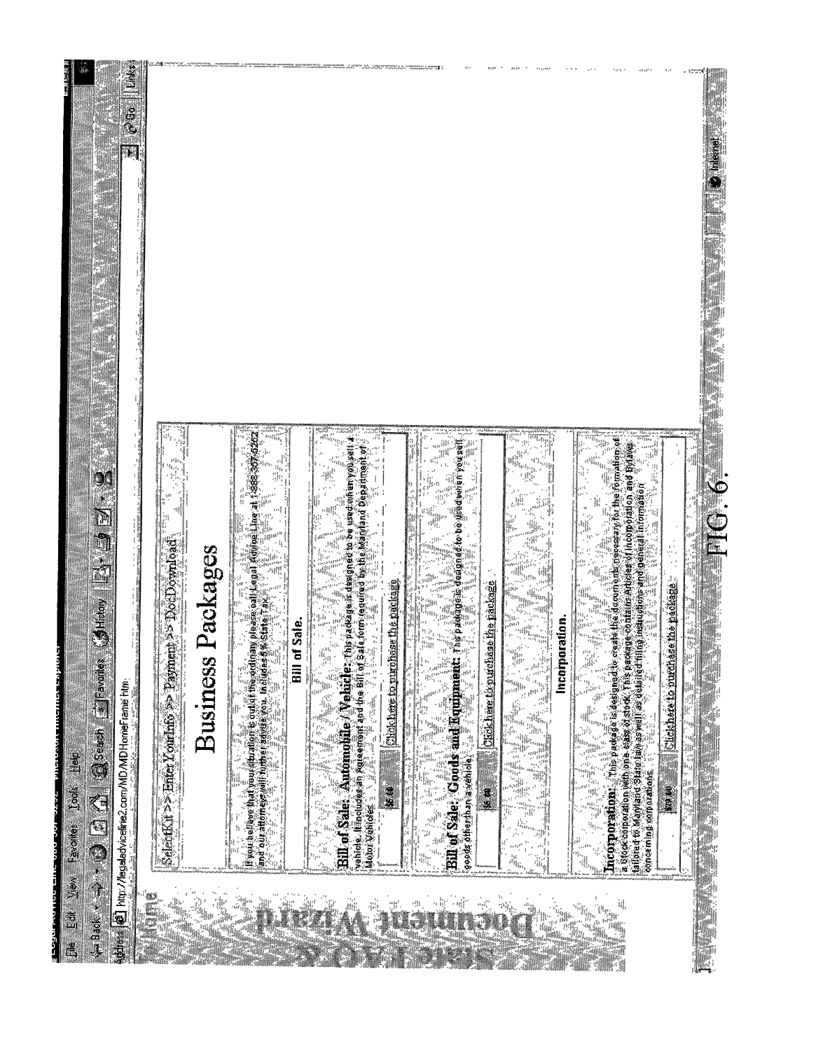

FIG. 5 is a block diagram of the specific document delivery architecture for direct browser delivery of rich text format documents in accordance with the method of FIG. 4. As seen in FIG. 5, a client 12 residing in one state X uses their client station to connect through the internet to the service provider network (SPN) 10, where they interact with lawyer 300 and attempt to obtain advice based upon the user's particular problems and questions.

As a first step, the client 12 indicates their home state from an HTML selection page. Next, client 12 is presented with a selection page in HTML format for indicating the type of law at issue. The selections may include the following:

Family

Child healthcare authorization

Adoption

Divorce

Answer to Complaint

Separation

Guardianship

Child Support

Custody/ Visitation

Personal

Advanced Directive (Living Will)

Wills

Name Change

Power of Attorney

Business

Bill of Sale

Incorporation

Board of Directors

General Release

Non Compete

Non Disclosure

Promissory Notes

Termination Letter

Court

File Notice of Lien

Garnishment On Wages

Garnishment on Property

Notice of Satisfaction

Renewal of Money Judgements

Small Claim Filing

Writ of Execution

If the client 12 selects Business, they are next presented with a purchase page such as shown in FIG. 6. From this, the client can select from available business documents simply by clicking on the appropriate button. If, for instance, the client 12 selects an automobile bill of sale, they are presented with an expert questionnaire 410 created in HTML format with all appropriate questions.

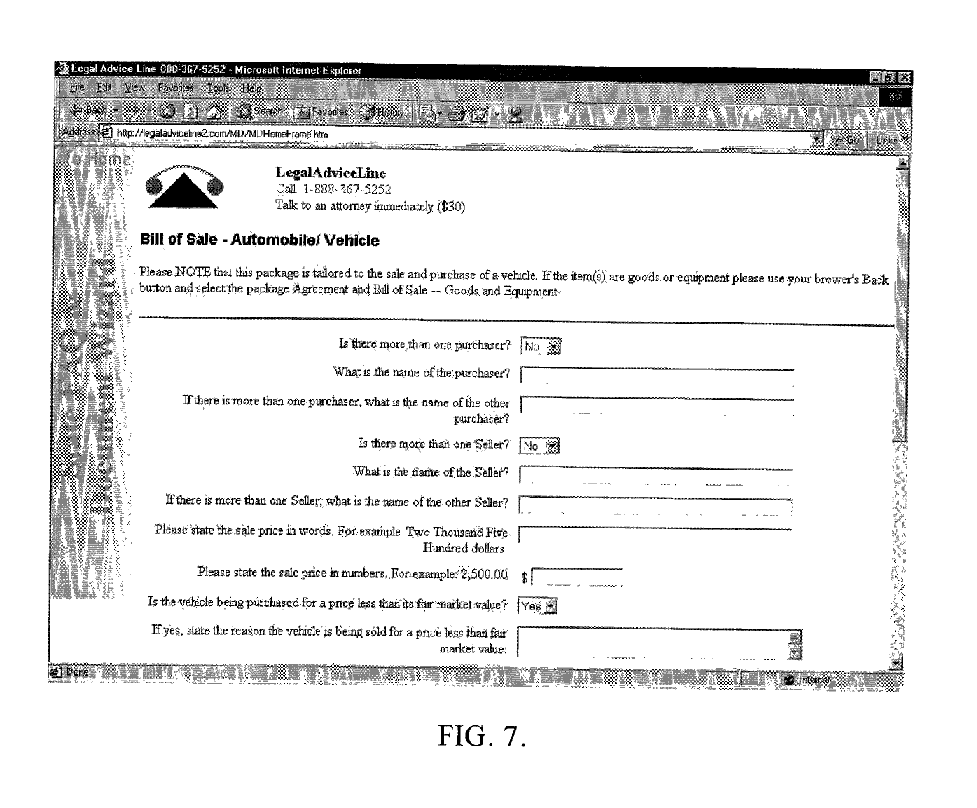

FIG. 7 is an example of the auto bill of sale questionnaire, and if the client scrolls down they will encounter all of the following questions:

Is there more than one purchaser?

What is the name of the purchaser?

If there is more than one purchaser, what is the name of the other purchaser?

Is there more than one Seller?

What is the name of the Seller?

If there is more than one Seller, what is the name of the other Seller?

Please state the sale price in words.

Please state the sale price in numbers.

Is the vehicle being purchased for a price less than its fair market value?

If yes, state the reason the vehicle is being sold for a price less than fair market value:

What is the vehicle's year?

What is the vehicle's make?

What is the veicle's body style, i.e., 4-door, 2-door?

What is the vehicle's model?

What is the vehicle's Vehicle Identification Number (VIN)?

What is the odometer reading?

Is the mileage of the vehicle in excess of its mechanical limits? Yes No

Is the odometer reading the actual mileage?

The user 12 completes the HTML questionnaire 410 with information specific to their particular legal matter. The information from the HTML questionnaire is transferred directly back to the SPN 10 server. When the client hits the submit button the SPN 10 server begins a recursive document assembly process to merge the information into a skeleton form document as will be described.

While the user is on-line, the attorney 300 uses his/her own desktop computer interface 420 to authorize the service provider network (SPN) 10 to retrieve a typical “skeleton” form legal document as appropriate for indicated need of client 12, and the selected skeleton document 430 is generated under attorney control by the staff of the SPN 10.

As mentioned above, as soon as the client 12 hits the submit button a script logic engine 450 resident on the SPN 10 server combines the user 12 packet of information with the selected skeleton document line by line to create a completed document in RTF format. At this point the website informs the user 12 that their “package of personalized documents has been successfully created.” They are invited to “Select the method of payment that they wish to use.”, and they are given a document reference ID (for example “roycraigmdbosv491838587.rtf”). This transaction reference number allows retrieval of the document even after the connection is unexpectedly broken. Script logic engine 450 combines the user 12 packet of information with the selected skeleton document 430 to render a unique and personalized legal document 460, which is in turn submitted to a Visual Basic (VB) script export engine for translation to rich text format. The user downloads the completed documents during the current connection to the web site.

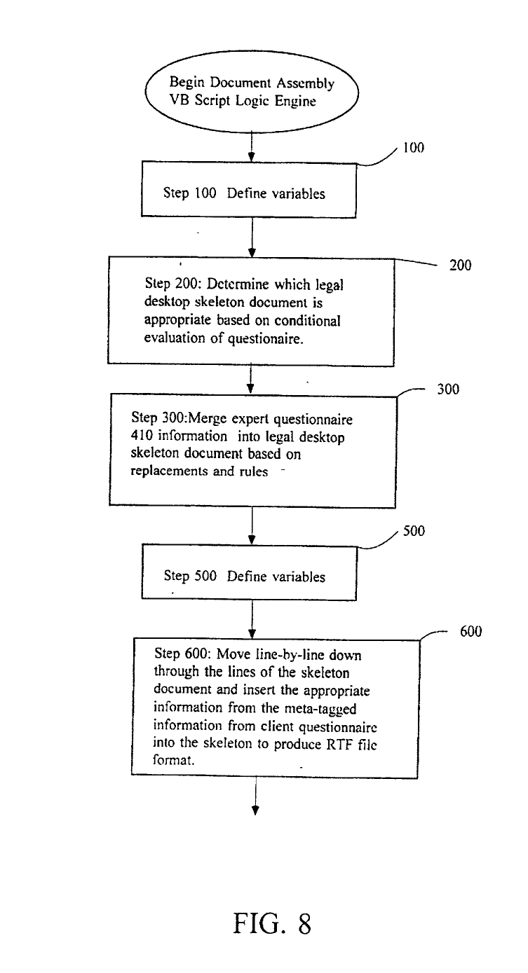

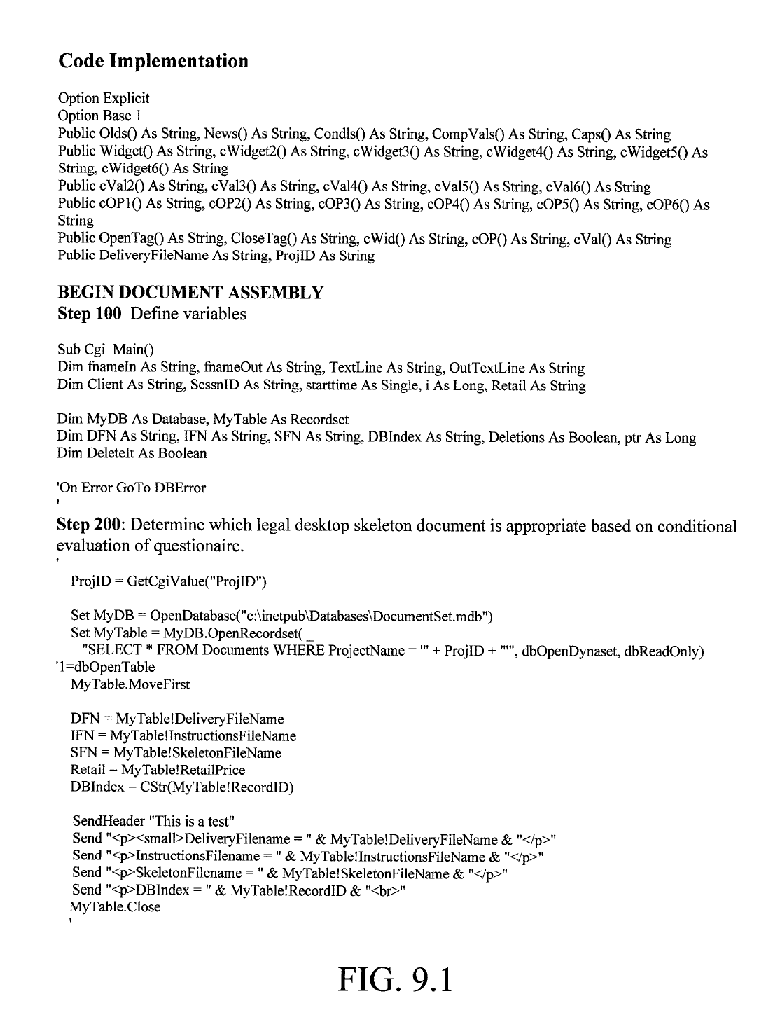

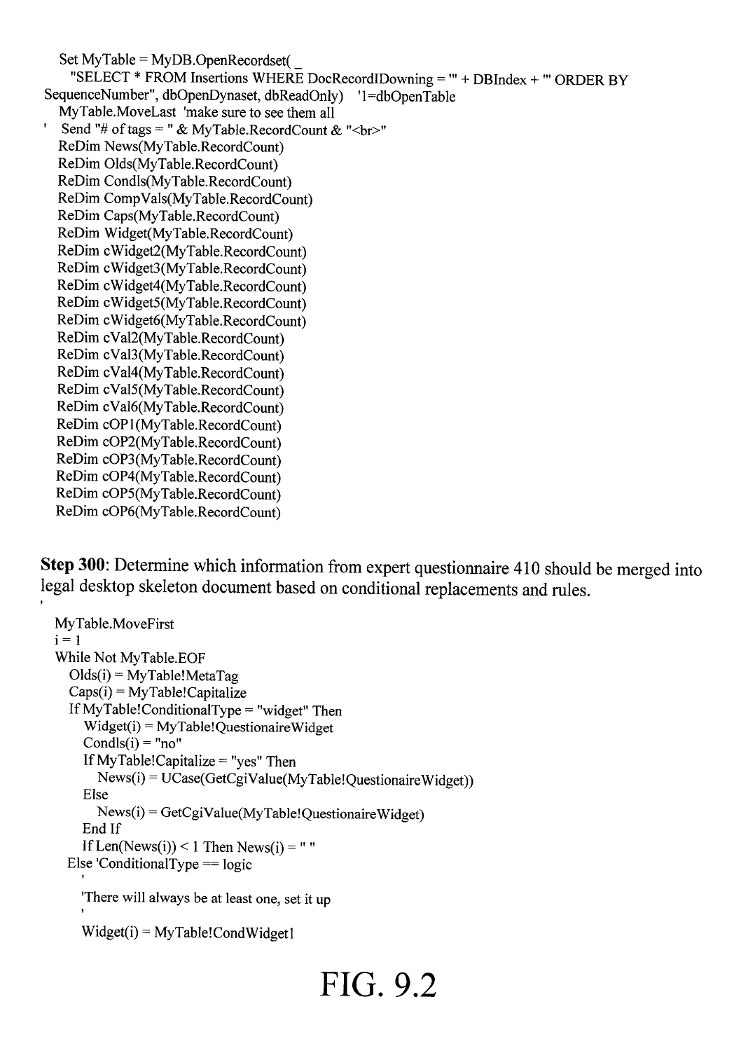

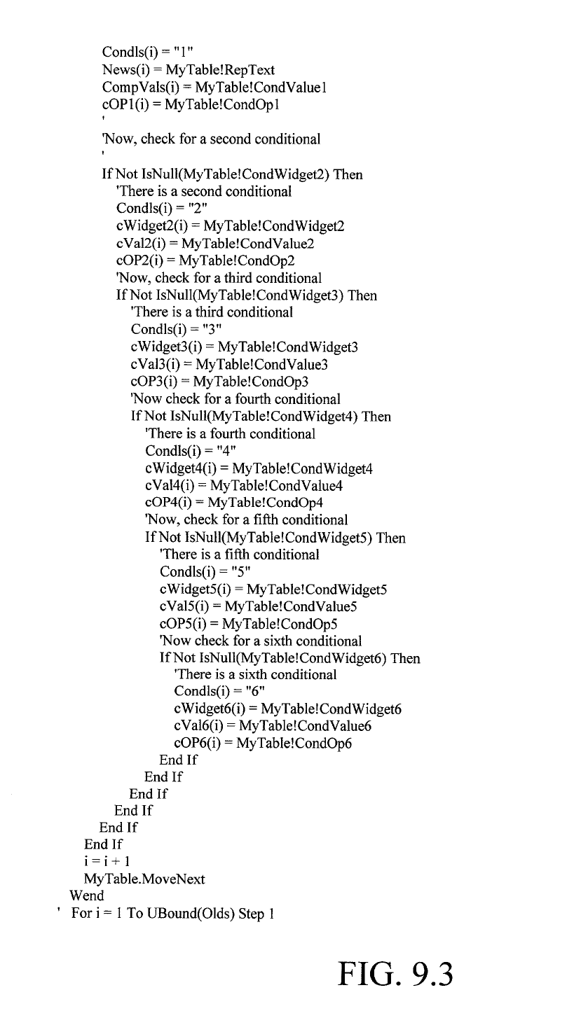

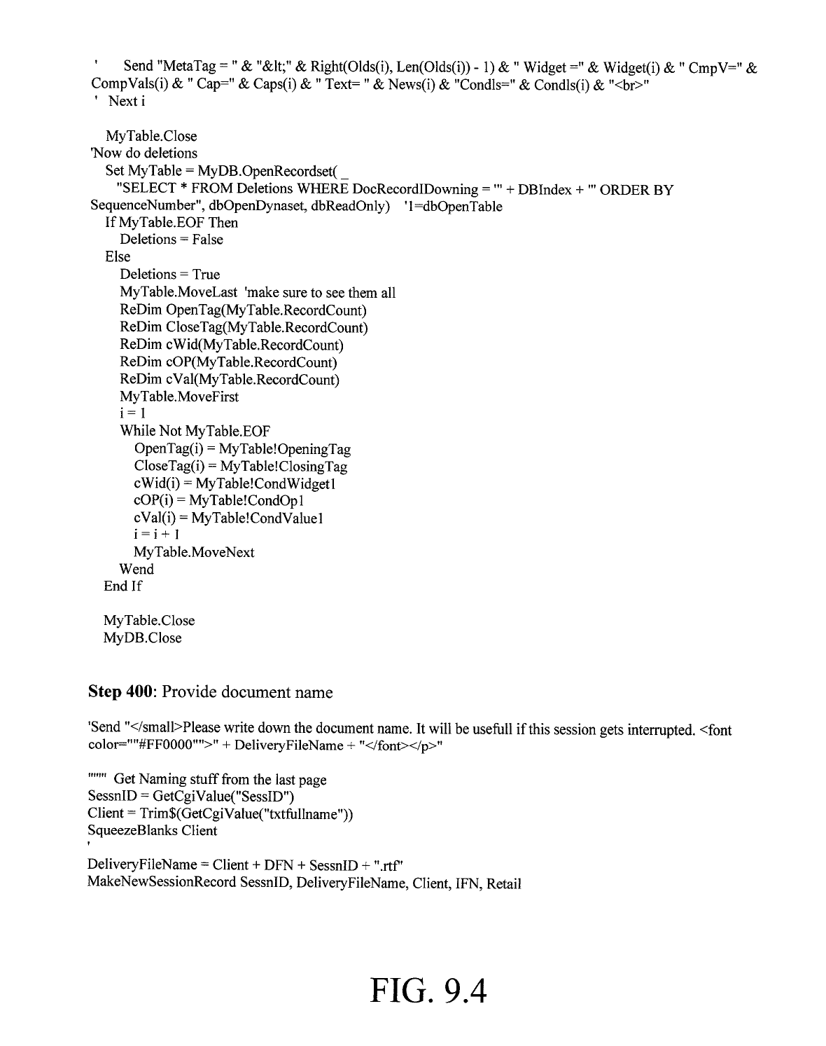

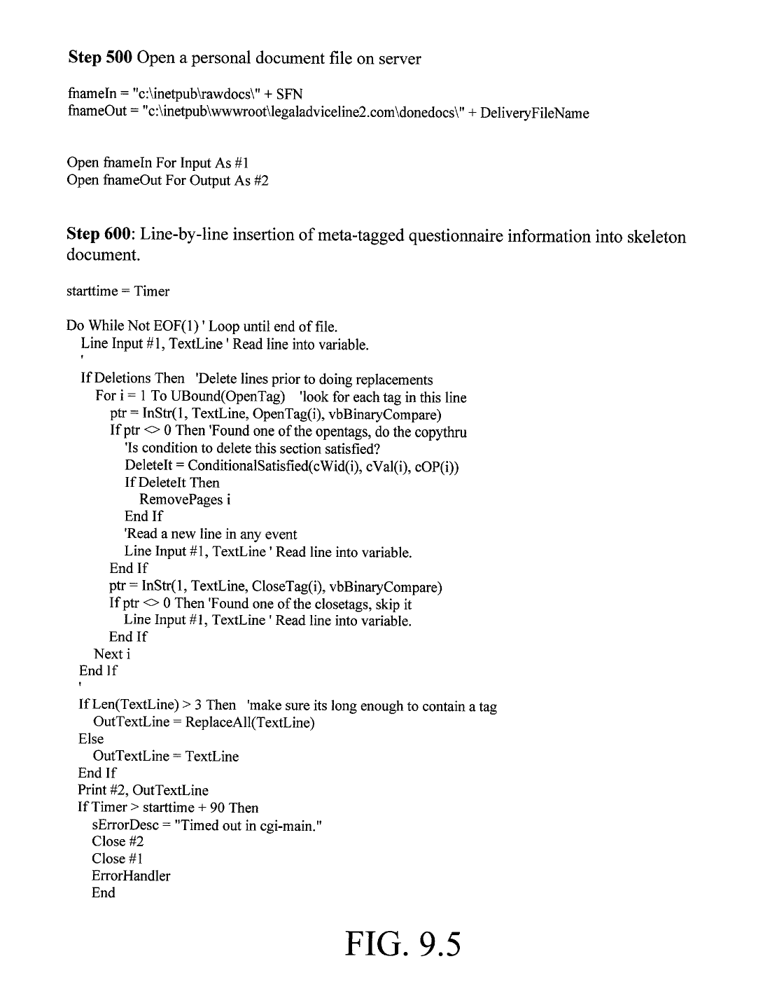

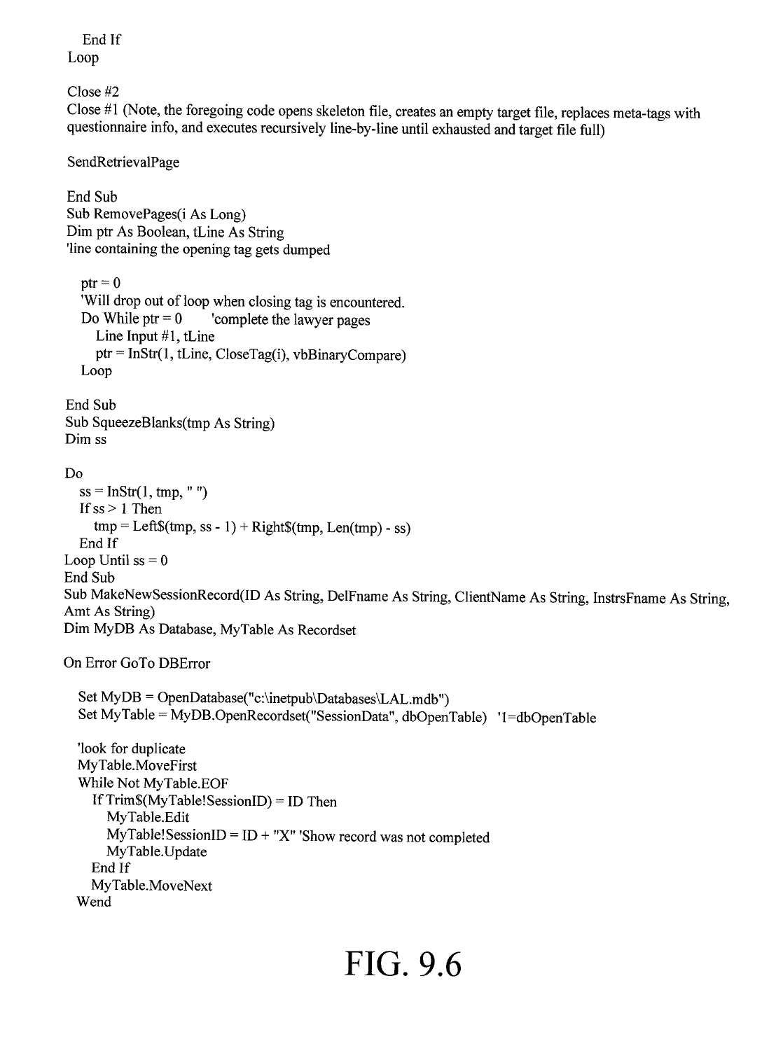

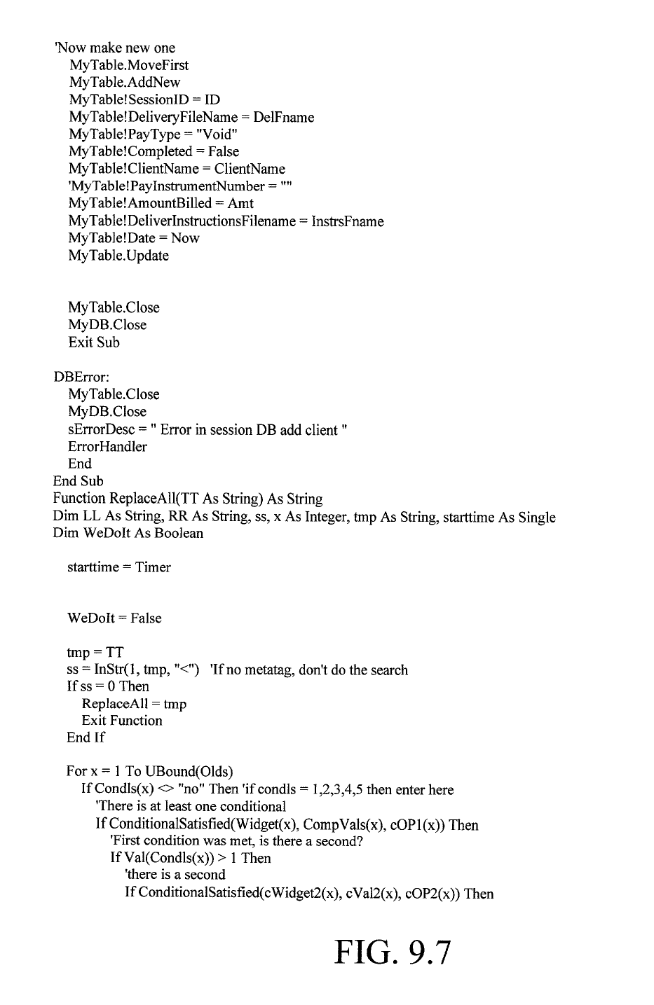

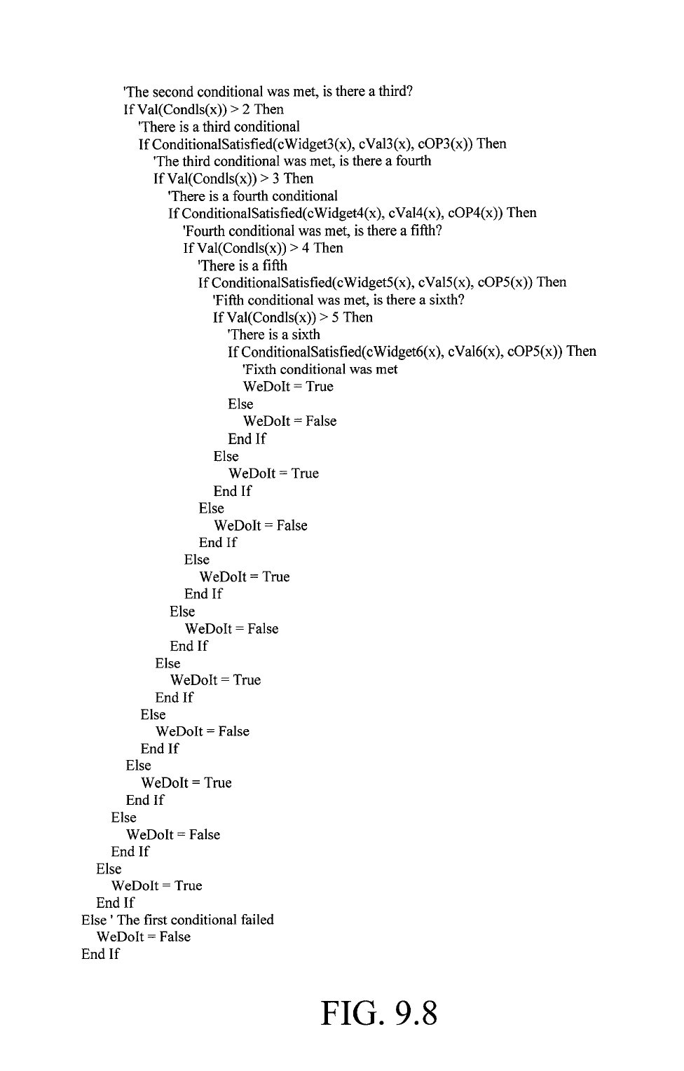

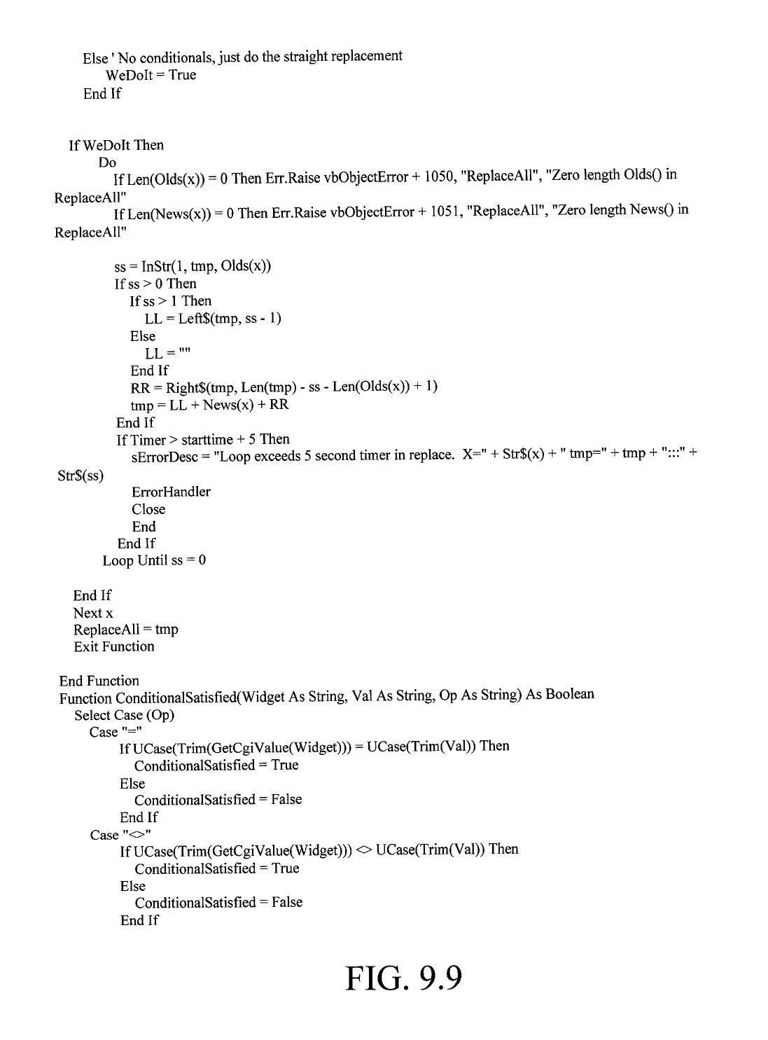

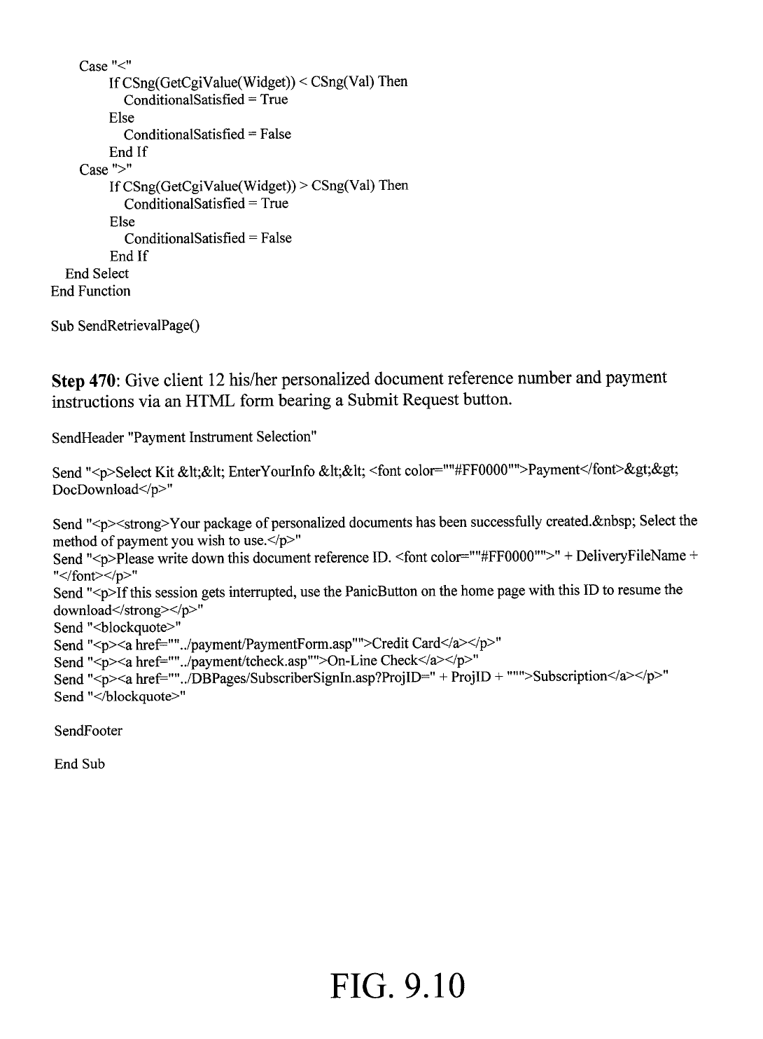

FIG. 8 is a top-level flow chart implementation of the VB script logic engine 450 of FIG. 5, and FIG. 9 is an exemplary visual basic implementation incorporating the flow chart of FIG. 8.

At step 100 (See FIGS. 8 and 9.1), the method defines all requisite variables.

At step 200 (See FIGS. 8 and 9.1), the method determines which legal desktop skeleton document is appropriate based on an “If” “Then” conditional evaluation of information and selections evaluation in the completed questionnaire.

At step 300 (See FIGS. 8 and 9.2), the server 10 determines which information from expert questionnaire 410 should be merged into legal desktop skeleton document based on conditional replacements and rules.

At step 500, the server 10 opens a target file to contain the finished RTF document.

The heart of the VB script logic engine begins at step 600 (See FIGS. 8 and 9.2), where the method moves line-by-line down through the lines of the skeleton document and inserts the appropriate information from the client questionnaire into the skeleton. The relevant information from the HTML questionnaire is identified by meta-tags, and meta-tagged information is inserted line-by-line into the skeleton document to yield a personalized document which is then stored in an output file in RTF format.

RTF (Rich Text Format) is a method of encoding formatted text and graphics for easy transfer between applications, and text and graphics interchange that can be used with different output devices, operating environments, and operating systems. RTF is an excellent document format for subscribers, but it is not easy to deliver directly to a browser. Most RTF documents produced by word processors are not readily postable to a browser window. As a result, it is difficult to implement completely and correctly. RTF (Rich Text Format) was designed by Microsoft as a standard format for interchanging documents between Microsoft Word and other word processing packages. With the RTF specification, documents created under different operating systems and with different software applications can be transferred between those operating systems and applications. The rich-text format attributes include:

Font name

Font size

Character color

Bold

Italic

Underline

Strikethrough

Bulleted lists

The line-by-line document assembly into RTF format is an important facet of the present invention. Conventional document assembly systems tend to use proprietary formats (such as Adobe®, or HTML. The former places restrictions on the client's ability to edit the document, and the latter was found to be a problem in the present context because the end appearance of an HTML document depends largely on the client's browser configuration. What looks like a perfect legal HTML document to the server 10 may lose a significant portion of its formatting on the client end, thereby looking and printing poorly. Thus, the present invention suggests a way of line-by-line merging of meta-tagged information directly into an RTF document, and then pointing the client to a URL location on the server 10 which contains the RTF document. The foregoing is interwoven with the online collection of payment. Once the client pays, the client's browser opens a new window that recognizes the RTF format and displays a perfectly formatted document on the client workstation every time. Moreover, the client is free to cut text and paste directly, or save and open files using their own word processor. The specific method steps will now be described, and it should be noted that this form of Rtf document assembly and delivery may be equally useful in many other contexts outside the legal field.

Referring back to FIG. 5, the personalized legal document is complete at step 460. The next steps are to secure payment and deliver the RTF document. This begins at step 470 where the client 12 is given a personalized document reference number (for tracking and recovery purposes) and payment instructions. The foregoing information is coded along with prompts for payment details (credit card type, number, etc.) onto an HTML form that bears a Submit Request button at the bottom. The form instructs the client to complete the information, whereupon the client submits the payment information at step 480 and the information is transmitted back to the server 10 for verification or confirmation.

All that remains is to deliver the RTF document in the most convenient manner to the client 12 (note that the personalized document file now resides on the server 10 and the client 12 is using their browser). At this point, and as shown at step 485, the server 10 generates a document request HTML form for the client with a pointer to the server 10 url containing the RTF personalized document file. The pointer to the server 10 url appears in the client's browser window as a push-button prompt to obtain access to the completed document. When the client pushes the button the HTML is scripted to open a secondary browser window on the client workstation for displaying the RTF document. Conventional browsers are intelligent enough to recognize the RTF file. Consequently, as shown at step 490, the software opens a new browser window on the client's computer screen and ports the RTF document directly into it.

The foregoing provides an efficient and effective RTF document delivery method where subscribers are free to copy documents into their own word processors for modification at will.

Having now fully set forth the preferred embodiments and certain modifications of the concept underlying the present invention, various other embodiments as well as certain variations and modifications thereto may obviously occur to those skilled in the art upon becoming familiar with said underlying concept. For example, the particular RTF document delivery architecture for direct browser delivery of rich text format documents may be practiced outside the legal document context. For example, is thought that the RTF document delivery architecture will have widespread utility in other contexts such as creating custom on line quotations from an on-line product catalogue, college applications, and resume production and online job application procedures, examination administration, etc. It is to be understood, therefore, that the invention may be practiced otherwise than as specifically set forth herein.

I claim:

1. A method for automated provision of legal documents, comprising the steps of:
maintaining a database of generic legal forms on a server;
receiving user information from a user over an electronic communications link and packetizing said user information;
receiving payment for a legal document using at least a portion of the user information received from the user;
rendering a personalized legal document for said user by selectively merging the packetized user information into said selected generic legal form;
delivering said personalized legal document to said user in a secondary browser window on said user's computer screen by RTF document export.

2. The method for automated provision of legal documents according to claim 1, wherein said step of receiving user information from a user further comprises taking information specific to a particular legal matter from an HTML questionnaire, and transferring said information from the HTML questionnaire directly back to the server.

3. The method for automated provision of legal documents according to claim 2, wherein said step of rendering a personalized legal document for said user further comprises a recursive document assembly process that merges said information into a skeleton form document selected in accordance with the particular legal matter.

4. The method for automated provision of legal documents according to claim 3, wherein said recursive document assembly process further comprises combining said user packet of information with the selected skeleton document line by line to create a completed document in RTF format.

5. The method for automated provision of legal documents according to claim 4, wherein relevant information from the HTML questionnaire is identified by meta-tags, and said meta-tagged information is inserted line-by-line into the skeleton document to yield a personalized document stored in an output file in RTF format.

6. A method of RTF document assembly, comprising the steps of:
maintaining a database of form documents;
requiring a user to complete an online HTML questionnaire with personalized information;
merging the personalized information from said HTML questionnaire into the form document by line-by-line writing selected information in RTF format into an output file;
securing payment authorization from said user;
outputting an HTML form to said user that contains a URL pointer to said RTF output file;
opening a secondary browser window upon user-selection of the pointer and displaying said RTF document therein.

7. A method of rendering a personalized legal document for a user, comprising the steps of:
maintaining a database of generic legal forms on a server;
collecting information on said user's legal needs without requiring identification information from said user by requiring said user to complete a form and transmitting said information over an electronic communications link;
requiring an attorney to choose a suitable legal form from said database of generic legal forms based on said collected information and while preserving anonymity of the user relative to the lawyer;
rendering a personalized legal document for said user by selectively merging the user information into said selected generic legal form;
delivering said personalized legal document to said user in a secondary browser window on said user's computer screen by RTF document export.
